(19) United States
(12) Patent Application Publication
(10) Pub. No.: US 2009/0309078 A1
(43) Pub. Date: Dec. 17, 2009

(54) POWER NAIL EXTRACTOR

(76) Inventor: Mark Waterman, St. Johns (CA)

Correspondence Address: James Ray & Associates, 2640 Pitcairn Road, Monroeville, PA, 15146, US

(21) Appl. No.: 12/482,894

(22) Filed: Jun. 11, 2009

Related U.S. Application Data
(60) Provisional application No. 61/131,670, filed on Jun. 11, 2008.

(51) Int. Cl. B25C 11/00; B23P 19/04

(52) U.S. Cl. 254/18; 29/252; 29/254

(57) ABSTRACT

The present invention is a device that can extract nails from any material. The present invention is particularly useful in extracting nails from wood, thus allowing any person involved in building construction to correct mistakes, and reuse old lumber and nails. Preferably, the device uses compressed air to power a pneumatic hammer type device which is connected to one of several possible nail extraction bits or other purpose bits.

### CROSS REFERENCE TO RELATED APPLICATION

This patent application is related to and claims priority from U.S. Provisional Patent Application Ser. No. 61/131,670 filed Jun. 11, 2008.

### FIELD OF THE INVENTION

This invention generally pertains to nail extractors. More specifically, the present invention relates to a pneumatically powered nail extractor.

### BACKGROUND OF THE INVENTION

The invention is particularly applicable to pneumatically powered nail extractors and will be described with particular reference thereto. However, it will be appreciated by those skilled in the art that the invention has broader applications and may also be adapted to use hydraulic actuation, electric actuation, mechanical actuation and the like.

Various means and methods have been developed over the years for use in extracting or removing nails, pins, spikes and the like from wood and the like. Perhaps, the most common nail extraction tools are the typical claw hammer and the typical crowbar. These tools require the user to force the distal end of the claw hammer or crowbar under the head of the nail, and then to use the claw hammer or crowbar as a lever to urge the head of the nail upward. The problems associated with removing a nail or the like that has been completely driven into a workpiece or the like so that the head of the nail is flush or even slightly below the outer surface of the workpiece are well known and include sever damage to the surface of the workpiece, injury to the worker attempting to use a claw hammer or crowbar to remove such nails, etc. Typically, a claw hammer, crowbar or pry bar is used to first pry the workpiece from its attached structure in hopes of exposing the head of the nail. However, this often results in breaking the lumber or underlying structure. Present devices and methods used to remove nails holding plywood or sheeting to existing structure usually results in broken plywood or sheeting.

Accordingly, it has been considered desirable to develop a new and improved nail extractor which would overcome the foregoing difficulties and others while providing better and more advantageous overall results

### SUMMARY OF THE INVENTION

The present invention is a device that can extract nails from any material. The present invention is particularly useful in extracting nails from wood, thus allowing any person involved in building construction to correct mistakes, and reuse old lumber and nails. Preferably, the device uses compressed air to power a pneumatic hammer type device which is connected to one of several possible nail extraction bits or other purpose bits. When the pneumatic hammer device is pneumatically powered its piston rod extends and vibrates a hammer, thus moving a set of teeth from an attached extraction bit around the head of a nail. While the hammer vibrates the extraction bit a slip ring is used to tighten the at least two flexible arms associates with said teeth around an embedded nail. Once the head of the nail is locked in and properly griped by the extraction bit by means of the slip ring or the like, the compressed air is used to retract the piston rod and pull the nail out of the material. The hammer can then be vibrated with the attached extraction bit to loosen the slip ring from the extraction bit, thus releasing the extracted nail.

One of the benefits of the present invention over the prior art is the vibrating hammer and attached extraction bit. The vibration of the extraction bit aides in moving the extraction bit around the head of a nail, and on stubborn nails or the like vibrates the nail to lessen friction with the surrounding wood or cement. The vibrating hammer also helps lessen the friction of the slip ring over the arms of the extraction bit, thus aiding in locking and unlocking the extraction bit arms and attached teeth.

The present invention could be constructed of the same or similar materials as traditional nail extraction devices. Preferably, the invention is constructed of metal or metal alloy. For example the present invention could be constructed of steel, copper, brass, aluminum, titanium or the like. The material chosen will largely depend on cost considerations and the level of strength desired. Preferably, the device is constructed substantially of aluminum and steel.

### OBJECTS OF THE INVENTION

It is therefore one of the primary objects of the present invention to provide a powered nail extractor for extracting nails.

Another object of the present invention is to provide a pneumatically powered nail extractor for extracting nails.

Still another object of the present invention is to provide a pneumatically powered nail extractor with a three tooth extraction bit.

In one embodiment the invention is a device for extracting a nail from a workpiece, said device comprising: an extraction bit having a first end and a second end; at least two leg members, each of said leg members having a first end and a second end, said first end of each of said leg members being attached to said second end of said extraction bit; and at least one slip ring means slidably positioned over at least a portion of said leg members for causing said second ends of said leg members to be urged inwardly; at least one vibration means mechanically coupled to said first end of the extraction bit. In another embodiment said at least one vibration means comprises a pneumatic hammer type device. In yet another embodiment the device further comprises a double action pneumatic cylinder and a frame for providing mechanical support for pulling said nail with said double action pneumatic cylinder. In still another embodiment said at least one vibration means comprises a pneumatic hammer type device capable of impacting at least once per second. In still yet another embodiment said at least one vibration means comprises a pneumatic hammer type device capable of impacting at least ten times per second.

In another embodiment the invention is a device for extracting a nail from a workpiece, said device comprising: an extraction bit having a first end and a second end; at least three leg members, each of said leg members having a first end and a second end, said first end of each of said leg members being attached to said second end of said extraction bit; at least one slip ring means slidably positioned over at least a portion of said leg members for causing said second ends of said leg members to be urged inwardly; and a pneumatic hammer type device mechanically coupled to said first end of the extraction bit. In yet another embodiment the device further comprises a double action pneumatic cylinder and a frame for providing mechanical support for pulling said nail with said double action pneumatic cylinder. In still another embodiment the device is constructed substantially of a combination of aluminum and steel. In still yet another embodiment said pneumatic hammer type device is capable of impacting at least once per second. In yet still another embodiment said pneumatic hammer type device is capable of impacting at least ten times per second.

In yet another embodiment the invention is a device for extracting a nail from a workpiece, said device comprising: an extraction bit having a first end and a second end; at least three leg members, each of said leg members having a first end and a second end, said first end of each of said leg members being attached to said second end of said extraction bit; at least one slip ring means slidably positioned over at least a portion of said leg members for causing said second ends of said leg members to be urged inwardly; a pneumatic hammer type device mechanically coupled to said first end of the extraction bit; and a double action pneumatic cylinder; and a frame for providing mechanical support for pulling said nail with said double action pneumatic cylinder. In still another embodiment the device is constructed substantially of a combination of aluminum and steel. In yet another embodiment said pneumatic hammer type device is capable of impacting at least once per second. In yet still another embodiment said pneumatic hammer type device is capable of impacting at least ten times per second.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective drawing of a preferred embodiment of the present invention with piston rod extended.

FIG. 2 is a general perspective drawing of a preferred embodiment of the present invention with piston rod retracted.

FIG. 3 is a perspective drawing of a three tooth extraction bit.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

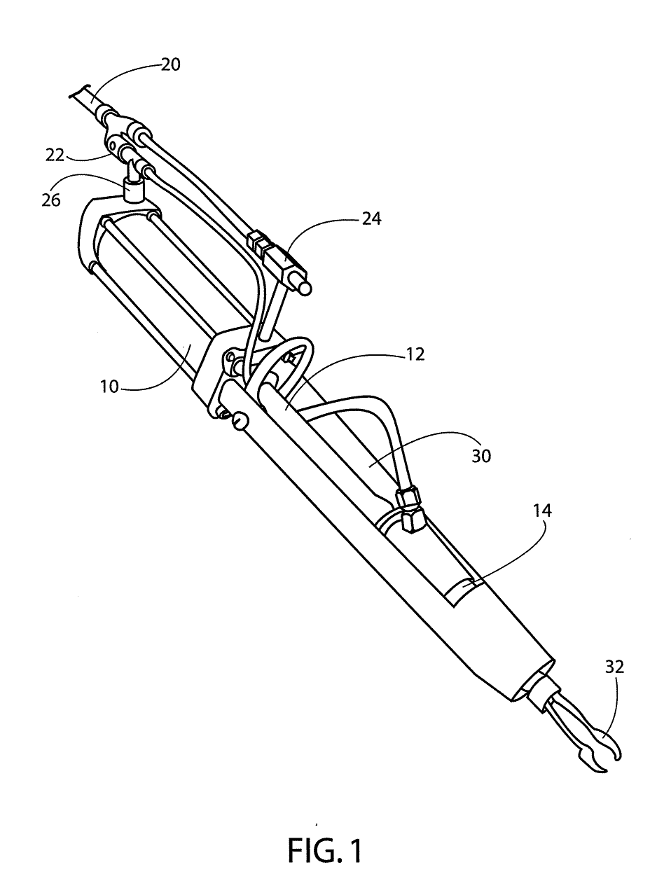

Reference is now made, more particularly, to FIG. 1 which is a general perspective drawing of a preferred embodiment of the present invention with piston rod extended. The invention comprises double action pneumatic cylinder 10 with piston rod 12 mechanically attached to pneumatic hammer 14. The device is pneumatically powered by means of hose 20 which could be attached to an air compressor (not shown). Valve A 22 is used to control pneumatic hammer 14, while Valve B 24 is used to control movement of piston rod 12. Pressure in double action pneumatic cylinder 10 can be regulated by pressure regulator 26. Attached to double action pneumatic cylinder 10 is aluminum frame 30 which provides mechanical support for pulling nails and a place for the user to grip the device. Mechanically coupled to pneumatic hammer 14 is extraction bit 32. Extraction bit 32 could be coupled to pneumatic hammer 14 by any means know in the art. Preferably extraction bit 32 is coupled in way that allows for quick exchanging or swapping of bits.

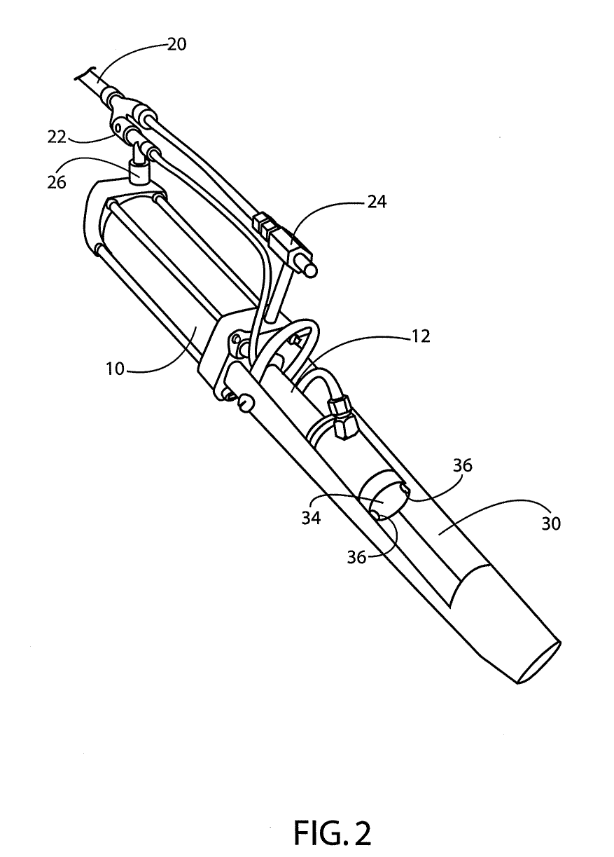

Reference is now made, more particularly, to FIG. 2 which is a general perspective drawing of a preferred embodiment of the present invention with piston rod retracted. The invention comprises double action pneumatic cylinder 10 with piston rod 12 mechanically attached to pneumatic hammer 14. The device is pneumatically powered by means of hose 20 which could be attached to an air compressor (not shown). Valve A 22 is used to control pneumatic hammer 14, while Valve B 24 is used to control movement of piston rod 12. Pressure in double action pneumatic cylinder 10 can be regulated by pressure regulator 26. Attached to double action pneumatic cylinder 10 is aluminum frame 30 which provides mechanical support for pulling nails and a place for the user to grip the device. Mechanically coupled to pneumatic hammer 14 is a chuck 34 with steel ears 36. Extraction bit 32 (not shown) includes complementing steel ears 44 for easy attachment. By placing the extraction bit 32 into chuck 34 and rotating to align steel ears 44 of bit and steel ears 36 to secure the extraction bit 32 in place.

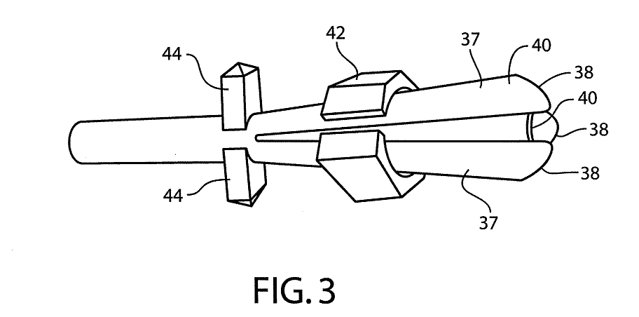

Reference is now made, more particularly, to FIG. 3 which is a perspective drawing of a three tooth extraction bit. Three tooth extraction bit comprises flexible leg members 37 with attached extraction teeth 38 with groove 40 for gripping and extracting nails. Groove 40 is positioned on the inside of extraction teeth 38 to preferably grab the head of a nail or to provide added friction for pulling out a headless nail. Slip ring 42 is used to tighten or loosed grip of extraction teeth 38 on a nail. Steel ears 44 are used in conjunction with steel ears 36 of chuck 34 to secured extraction bit to pneumatic hammer 14. By placing the extraction bit 32 into chuck 34 and rotating to align steel ears 44 of bit and steel ears 36 to secure the extraction bit 32 in place. While a three tooth extraction bit is shown, the bit could be modified with any number of teeth and accompanying flexible legs. In particular two and four tooth extraction bits are envisioned.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A device for extracting a nail from a workpiece, said device comprising:
an extraction bit having a first end and a second end;
at least two leg members, each of said leg members having a first end and a second end, said first end of each of said leg members being attached to said second end of said extraction bit; and
at least one slip ring means slidably positioned over at least a portion of said leg members for causing said second ends of said leg members to be urged inwardly;
at least one vibration means mechanically coupled to said first end of the extraction bit.

2. A device as claimed in claim 1, wherein said at least one vibration means comprises a pneumatic hammer type device.

3. A device as claimed in claim 1, further comprising a double action pneumatic cylinder and a frame for providing mechanical support for pulling said nail with said double action pneumatic cylinder.

4. A device as claimed in claim 1, wherein said at least one vibration means comprises a pneumatic hammer type device capable of impacting at least once per second.

5. A device as claimed in claim 1, wherein said at least one vibration means comprises a pneumatic hammer type device capable of impacting at least ten times per second.

6. A device for extracting a nail from a workpiece, said device comprising:
an extraction bit having a first end and a second end;
at least three leg members, each of said leg members having a first end and a second end, said first end of each of said leg members being attached to said second end of said extraction bit;
at least one slip ring means slidably positioned over at least a portion of said leg members for causing said second ends of said leg members to be urged inwardly; and
a pneumatic hammer type device mechanically coupled to said first end of the extraction bit.

7. A device as claimed in claim 6, further comprising a double action pneumatic cylinder and a frame for providing mechanical support for pulling said nail with said double action pneumatic cylinder.

8. A device as claimed in claim 6, constructed substantially of a combination of aluminum and steel.

9. A device as claimed in claim 6, wherein said pneumatic hammer type device is capable of impacting at least once per second.

10. A device as claimed in claim 6, wherein said pneumatic hammer type device is capable of impacting at least ten times per second.

11. A device for extracting a nail from a workpiece, said device comprising:
an extraction bit having a first end and a second end;
at least three leg members, each of said leg members having a first end and a second end, said first end of each of said leg members being attached to said second end of said extraction bit;
at least one slip ring means slidably positioned over at least a portion of said leg members for causing said second ends of said leg members to be urged inwardly;
a pneumatic hammer type device mechanically coupled to said first end of the extraction bit; and
a double action pneumatic cylinder; and
a frame for providing mechanical support for pulling said nail with said double action pneumatic cylinder.

12. A device as claimed in claim 11, constructed substantially of a combination of aluminum and steel.

13. A device as claimed in claim 11, wherein said pneumatic hammer type device is capable of impacting at least once per second.

14. A device as claimed in claim 11, wherein said pneumatic hammer type device is capable of impacting at least ten times per second.
